(19) United States
(12) Patent Application Publication
(10) Pub. No.: US 2022/0330469 A1
(43) Pub. Date: Oct. 20, 2022

(54) APPARATUS, SYSTEM AND METHOD FOR MARKING A FIELD

(71) Applicant: Precision Planting LLC, Tremont, IL (US)

(72) Inventors: Jeremy Hodel, Morton, IL (US); Timothy Kater, Bloomington, IL (US); Jason Stoller, Eureka, IL (US); Isaac Carr, Cedar Springs, MI (US); Douglas Urbaniak, Mackinaw, IL (US); John Weigand, Goodfield, IL (US)

(21) Appl. No.: 17/753,137

(22) PCT Filed: Jun. 17, 2020
(86) PCT No.: PCT/IB2020/055639

§ 371 Date: Feb. 21, 2022

Related U.S. Application Data
(60) Provisional application No. 62/889,678, filed on Aug. 21, 2019.
(60) Provisional application No. 62/962,780, filed on Jan. 17, 2020.

(51) Int. Cl. A01B 79/02; A01C 7/08; A01D 41/127

(52) U.S. Cl. CPC A01B 79/02; A01C 7/081; A01D 41/127

(57) ABSTRACT

A system (1000) and method of marking soil or crops within afield with a visual strip (1001) to identify an occurrence of a detected event as an agricultural implement (10) traverses a field. The system includes an assembly (100, 200, 300, 500, 700, 800, 900) supported by the agricultural implement. The assembly includes a supply of a colored composition and an actuator (130, 330, 1030) configured to receive the actuation signals sent by the controller (80, 81). The actuator is responsive to the actuation signals to release the colored composition at the location on the field while the agricultural implement advances through the field in the forward direction of travel.

### CROSS-REFERENCE TO RELATED APPLICATIONS

This application claims the benefit of the filing date of U.S. Provisional Patent Application 62/889,678, “Field Marking System and Method,” filed Aug. 21, 2019; and U. S. Provisional Patent Application 62/962,780, “Field Marking System and Method,” filed Jan. 17, 2020; the entire disclosure of each of which is incorporated herein by reference.

### FIELD

This disclosure relates to methods and systems for marking fields, and particularly to applying a composition in agricultural fields to visually mark locations of detected events.

### BACKGROUND

Planter monitor systems that monitor and display to the operator the planter's operational performance are disclosed, for example, in U.S. Pat. No. 8,078,367, “Planter monitor system and method,” granted Dec. 13, 2011. A commercial embodiment is the 20/20 SeedSense® Monitor, available from Precision Planting. LLC, of Tremont, Ill., which monitors and displays seed population, seed skips, seed multiples, seed spacing, row unit downforce, and other planter operational performance criteria. U.S. Pat. No. 8,078,367 also discloses an algorithm for associating an economic loss value due to poor seed spacing.

U.S. Pat. No. 9,699,958, “Systems and methods for control, monitoring and mapping of agricultural applications,” granted Jul. 11, 2017, discloses mapping and display of a planter's operational performance overlaid on an aerial map of a field so the operator has a real-time, color-coded view of seed skips, seed multiples, poor seed spacing, and other planter operational performance criteria. A commercial embodiment is the FieldView® system, developed by Precision Planting, Inc., and now available from Climate Corporation, of San Francisco, Calif. U.S. Patent Publication 2019/0075710, “Seed trench depth detection systems,” published Mar. 14, 2019; U.S. Patent Publication 2019/0075714, “Seed trench closing sensors,” published Mar. 14, 2019; and International Patent Application Publication WO2019/099748, “Seed trench closing sensors,” published May 23, 2019; disclose mapping and display of soil data overlaid on an aerial map of a field, including soil moisture, soil temperature, soil electrical conductivity, organic matter, seed trench depth, and the closing efficacy of the seed trench, all of which can affect seed germination and uniformity of plant emergence.

The objective of providing on-screen, real-time data maps as disclosed in the above-identified patents, published patent applications and commercial embodiments is to provide the operator with an easily perceived visual indication (such as by color coding) of planter operational performance or soil conditions to identify events that adversely affect seed germination, plant emergence, or other conditions that can negatively impact yields. Such yield-impacting operational performance or conditions may include, but are not limited to, seed skips, seed multiples, seed spacing outside a predetermined range, downforce outside a predetermined range, trench depth outside a predetermined range, seed trench closing force outside a predetermined range, ride quality outside a predetermined range, soil moisture outside a predetermined range, soil temperature outside a predetermined range, and organic matter outside a predetermined range (which may each be referred to herein as a “detected event”). However, even though the visual data maps track and identify the GPS coordinates of such detected events, it is difficult and often time consuming for the operator to translate the on-screen data maps to the actual locations in the field when the operator desires to inspect the detected event in the field, whether immediately by stopping planting operations or especially at a later date. Because the precise physical location in the field is not visually marked on the soil, the operator will often end up uncovering extended lengths of seed trenches when searching for the detected events in the field. Accordingly, it would be desirable to provide a system that visually marks the soil with paint in the field where a detected event has occurred so the operator can quickly and easily identify and go to the area of the field where the detected event occurred when the operator desires to inspect that area or perform a subsequent operation over that area.

Rather than marking each detected event on the soil of the field, it may be desirable to visually mark the soil of the field only when a detected event exceeds a predefined parameter.

In addition to marking the soil of a field during planting operations to identify detected events, it may also be desirable to mark the soil of a field during other agricultural operations, such as during tilling operations, spraying operations, side-dress operations, or any other agricultural operation. Thus, the soil may be marked to identify a location in the field where any type of detected event occurs while traversing the field, which may be related to operational performance of the agricultural implement, to soil conditions, or to other monitored or measured conditions.

### BRIEF SUMMARY

A method of marking a field to identify a location where a detected event occurred within the field includes detecting or retrieving an occurrence of an event during a field operation, and applying a composition using an agricultural implement to visually mark a location within the field where the detected event occurred during the field operation.

A system for marking a field to identify a location where a detected event occurred within the field includes an agricultural implement configured to advance through a field in a forward direction of travel, at least one sensor configured to generate a sensor signal indicative of an operating condition of the agricultural implement at a location on the field, a controller in communication with and responsive to the generated sensor signal, the controller configured to send actuation signals, and a marking assembly supported by the agricultural implement. The marking assembly includes a supply of a colored composition and an actuator configured to receive the actuation signals sent by the controller. The actuator is responsive to the actuation signals to release the colored composition at the location on the field while the agricultural implement advances through the field in the forward direction of travel.

### BRIEF DESCRIPTION OF THE DRAWINGS

FIG. 1 is a top plan view of a tractor pulling a planter with a field marking system and showing a representation of the field being marked to identify detected events as the planter traverses a field.

FIG. 2 is a side elevation view of a planter row unit with one embodiment of a field marking assembly.

FIG. 3 is a perspective view of the field marking assembly of FIG. 2.

FIG. 4 is an enlarged perspective view of an embodiment of a paint canister holder and actuator of the field marking assembly of FIG. 2.

FIG. 5 is a side elevation view of a planter row unit with another embodiment of a field marking assembly.

FIG. 6 is an enlarged perspective view of another embodiment of a paint canister holder and actuator of the field marking system of FIG. 5.

FIG. 7 illustrates another embodiment of a field marking assembly.

FIG. 8 is a top plan view of a sprayer implement in a field with growing crops and showing an embodiment of a field marking assembly.

FIG. 9 is a cross-sectional view showing an embodiment of the field marking assembly on the spray implement boom as viewed along line 9-9 of FIG. 8.

FIG. 10 is a top plan view of a side-dress implement in a field with growing crops and showing another embodiment of a field marking assembly.

FIG. 11 is a cross-sectional view showing an embodiment of the field marking assembly on the side-dress implement as viewed along line 11-11 of FIG. 10.

FIG. 12 is a side elevation view of view of a tillage implement showing another embodiment of a field marking assembly.

FIG. 13 is a top plan view of a combine harvester implement in a field harvesting crops and showing another embodiment of a field marking assembly.

FIG. 14 is a cross-sectional view showing an embodiment of the field marking assembly as viewed along line 14-14 of FIG. 13.

FIG. 15 is a side elevation view of another embodiment of a field marking assembly mounted to a planter row unit, wherein the field marking assembly is configured to couple with a trench closing assembly having a press wheel.

FIG. 16 is a rear perspective view of the field marking assembly coupled with the trench closing assembly as shown in FIG. 15, but with the planter row unit removed.

FIG. 17 is a front perspective view of the field marking assembly coupled with the trench closing assembly as shown in FIG. 15, but with the planter row unit removed.

FIG. 18 is the same front perspective view of the field marking assembly and the trench closing assembly as in FIG. 17, but showing the field marking assembly uncoupled from the trench closing assembly.

FIGS. 19A and 19B are side elevation views of the field marking assembly coupled with the trench closing assembly as shown in FIG. 15, showing optional transport positions of the field marking assembly.

FIG. 20 is the same side elevation view of the field marking assembly and the trench closing assembly of FIG. 15, illustrating the function of stops on the field marking assembly when the row unit is in a raised position, such as when turning at headlands during planting operations.

FIG. 21 is an enlarged cross-sectional view of the field marking assembly as viewed along line 21-21 of FIG. 17.

### DETAILED DESCRIPTION

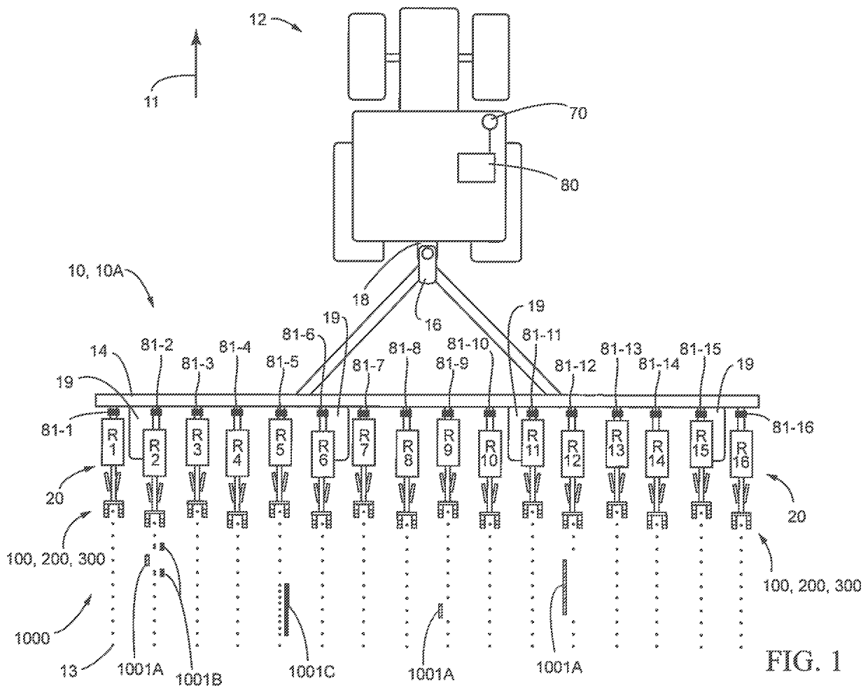

Referring now to the drawings, wherein like reference numbers designate the same or corresponding parts, FIG. 1 is a top plan view showing an implement 10 represented as a singulating row crop planter that incorporates a field marking system 1000 to mark the soil of a field with a visual strip 1001 to identify locations of any detected events that may occur as the implement 10 traverses a field during an agricultural operation. As used herein, the term “visual strip” refers to any visually perceptible mark that may be sprayed, dribbled, deposited, or otherwise applied onto the soil surface and that remains easily visually perceptible for a period of time to permit inspection. Examples of suitable compositions that may be used for applying a visual strip 1001, include, but are not limited to, paint or ink or some other liquid, such as water, that includes a pigment, dye, or other coloring agent. Alternatively, a powder composition that is colored with a pigment, dye, or other coloring agent may be suitable, but a powder composition may be more susceptible to blowing in windy conditions and may not flow freely in high-humidity conditions. Vanishing foam or vanishing spray can also be used for the visual strip. Vanishing foam is described in U.S. Pat. No. 7,074,264, “Foaming aqueous composition, use thereof and process for temporary demarcation of regulation distances in sports,” granted Jul. 11, 2006, and is used in soccer to apply a temporary line onto a playing field.

Although FIG. 1 shows the implement 10 as a singulating row crop planter, as discussed later, the field marking system 1000 may be adapted for any type of agricultural implement, including, but not limited to, an air seeder, a sprayer, a side-dress applicator, a tillage implement or any other agricultural implement instrumented with sensors in communication with a monitor to detect or measure the operational performance of the agricultural implement or the soil conditions as the implement traverses the field.

As used herein, the term “detected event” should be understood as meaning any operational performance criterion or soil condition that is monitored, measured, or otherwise detected as the implement traverses a field during an agricultural operation. Once detected from a first agricultural operation, the event can be stored in a memory. The event can be retrieved from memory and used in a second or subsequent agricultural operation to mark the field where the event occurred. Alternatively, the event can trigger marking without storing in a memory.

The exemplary embodiment of the implement 10 represented as a singulating row crop planter 10A in FIG. 1 includes a toolbar 14 from which is supported a plurality of laterally spaced row units 20. The planter 10 is shown as a sixteen-row planter, with each of sixteen spaced row units 20 respectively labeled by row R1 to R16, and each row unit 20 is shown as planting a row of seeds 13 as the planter advances through the field in a forward direction of travel indicated by arrow 11. Although the planter 10A is shown as a sixteen-row planter, the planter 10A may have any number of row units 20. Mounted rearward of each row unit 20 is a field marking system 1000 configured to spray, dribble, deposit, or otherwise apply the composition onto the soil of the field being planted, to visually mark the soil upon the occurrence of a detected event as the planter traverses the field. For illustration purposes only, and as non-limiting examples, a visual strip 1001A is shown adjacent to seed rows where one or more seed skip detected events have occurred, a visual strip 1001B is shown adjacent to seed rows where one or more seed multiple detected events have occurred, and a visual strip 1001C is shown adjacent to seed rows where a poor seed spacing detected event has occurred. The visual strip 1001 allows the operator to quickly and easily identify the area within a seed trench row where the detected event occurred in each seed trench row and, as explained later, the visual strip may be color-coded to visually identify the type of detected event that occurred.

The planter 10A is connected by a hitch 16 to a drawbar 18 of a tractor 12. Alternatively, the planter 10A may be mounted to the tractor 12 by a three-point hitch as is well known in the art. The toolbar 14 is typically supported by wheel assemblies 19 adapted to raise and lower the toolbar 14 relative to the soil surface between an operating position and a travel position. The row units 20 supported from the toolbar 14 may be staggered or longitudinally offset to accommodate narrower row spacing than side-by-side arrangement.

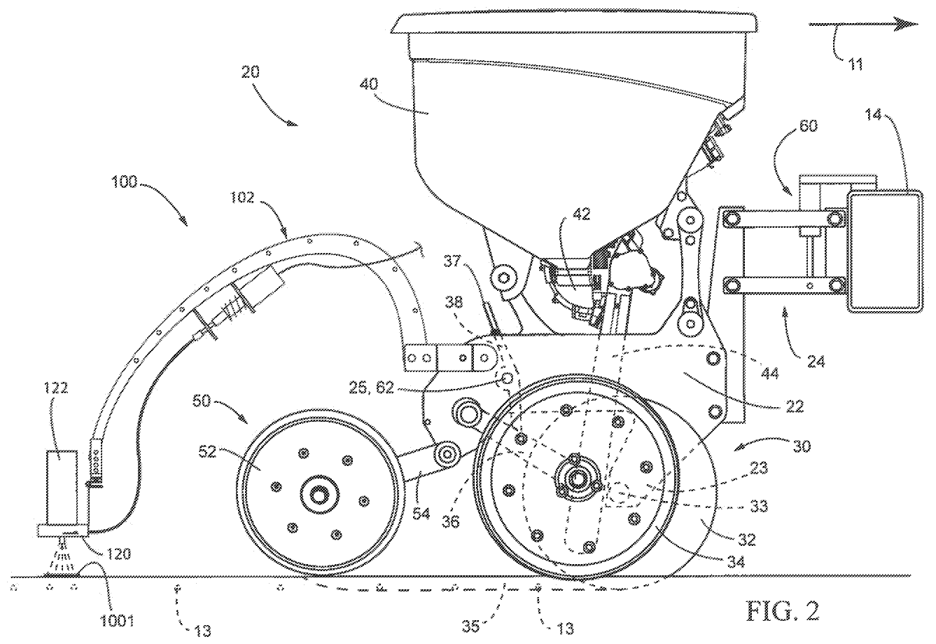

FIG. 2 is a side elevation view of an exemplary embodiment of one of the row units 20. An example of a commercially available row unit 20 is the Ready Row Unit™ from Precision Planting, LLC. The row unit 20 includes a frame 22 connected to the toolbar 14 via a parallel linkage 24. The parallel linkage 24 allows the row unit frame 22 to move upward and downward relative to the toolbar 14, thus allowing each of the row units 20 to move vertically independently of one another to accommodate changes in field terrain across the width of the planter or in the event one of the row units 20 encounters an obstruction, such as a rock, as the planter 10A traverses the field.

The row unit 20 includes a seed trench opening assembly 30 configured to open a seed trench or furrow 35 in the soil surface as the row unit 20 advances in the forward direction of travel 11. In one embodiment, the trench opening assembly 30 may include two opening disks 32 rotatably mounted on a shaft 33 supported from a downward extending shank portion 23 of the frame 22. The opening disks 32 are oriented to diverge outward and upward from one another at a contact point such that as the opening disks are lowered into the soil and the row unit advances forward in the direction of arrow 11, the rotating disks 32 cut or open a V-shaped trench or furrow 35 in the soil surface. The trench opening assembly 30 may further include a pair of gauge wheels 34 each disposed outwardly adjacent to one of the opening disks 32. The gauge wheels 34 may be rotatably connected to respective gauge wheel arms 36, which are pivotally connected at one end to the frame 22 such that the gauge wheels 34 are vertically positionable relative to the opening disks 34. A depth adjustment arm 38 may be pivotally mounted to the frame 22 about a pivot pin 25 and may be selectively positionable to limit the upward travel of the gauge wheel arms 36, thus setting a maximum relative distance between the bottom of the gauge wheels 34 and the bottom of the opening disks 32, which defines the depth of the trench 35. The depth adjustment arm 38 may be manually positionable via a handle 37, or the depth adjustment arm 38 may be configured to pivotally move about the pivot pin 25 using a depth adjustment actuator system as disclosed in U.S. Patent Publication 2019/0014714, “Agricultural trench depth systems, methods, and apparatus,” published Jan. 17, 2019; U.S. Patent Application Publication 2019/0000004, “Agricultural trench depth systems, methods, and apparatus,” published Jan. 3, 2019; and U.S. Pat. No. 8,909,436, “Remote adjustment of a row unit of an agricultural device,” granted Dec. 9, 2014.

Each row unit 20 also includes a seed hopper 40 supported on the frame 22 for holding a supply of seed to be deposited in the trench 35 as the row unit 20 advances in the forward direction of travel 11. As is known in the art, one or more additional hoppers may be supported on the frame for holding fertilizer, pesticides, or other inputs for dispensing as the row unit 20 advances in the forward direction of travel 11. The seed hopper 40 is in communication with a seed meter 42. The seed meter 42 is configured to dispense individual or singulated seeds into a seed tube or seed conveyor 44, which directs the singulated seeds 13 downward and rearward into the seed trench 35. Seed sensors are configured to detect each of the individual seeds 13 being deposited into the seed trench 35.

A closing assembly 50 closes the seed trench 35 with soil after the seeds 13 are deposited into the trench 35. The closing assembly 50 includes a pair of closing wheels 52 rotatably supported by a closing wheel arm 54 pivotally connected at one end to the frame 22. Each of the closing wheels 52 is disposed on one side of the trench 35 and the closing wheels 52 diverge upward while converging rearward to push the soil on either side of the trench 35 inwardly over the deposited seeds 13 as the row unit 20 advances in the forward direction of travel 11.

A hydraulic or pneumatic downforce actuator 60 may apply a down force or lift force to the row unit 20, such as the systems and methods used for downforce control disclosed in U.S. Pat. No. 9,288,937, “Apparatus, systems and methods for row unit downforce control,” granted Mar. 22, 2016; and U.S. Pat. No. 9,144,189, “Integrated implement downforce control systems, methods, and apparatus,” granted Sep. 29, 2015. A downforce sensor 62 may generate a signal related to the amount of force imposed by the gauge wheels 34 on the soil surface. In some embodiments, the pivot pin 25 may be instrumented as a downforce sensor 62 as disclosed in U.S. Pat. No. 8,561,472, “Load Sensing Pin,” granted Oct. 22, 2013.

The planter 10A, row units 20, trench opening assembly 30, and trench closing assembly 50 are not limited to the embodiments described above as each may have different configurations and components depending on the type of planter. For example, the planter 10A may be a central-fill planter, and the row units 20 may be configured with mini-hoppers. Alternatively, the planter 10A may be an air seeder. As another example, the trench opening assembly 30 may be a single disk opener with a single gauge wheel. All of the foregoing alternatives and others would be recognized and understood by those of ordinary skill in the art.

The tractor 12 includes a GNNS or GPS receiver 70 in signal communication with a monitor 80. The monitor 80 may include a central processing unit (“CPU”), memory, and a graphical user interface (“GUI”) to allow the operator to view the operational performance of the planter. One such monitor is disclosed in U.S. Pat. No. 8,078,367, mentioned above, a commercial embodiment of which is the 20/20 SeedSense® Monitor. The 20/20 SeedSense® Monitor may incorporate the FieldView® real-time data visualization technology disclosed in U.S. Pat. No. 9,699,958. The FieldView® data visualization technology is currently available from Climate Corporation. The 20/20 SeedSense® Monitor may also incorporate the real-time data visualization technology disclosed in U.S. Patent Publication 2019/0075710, U.S. Patent Publication 2019/0075714, and International Patent Publication WO2019/099748, mentioned above. The real-time data visualization technology disclosed in the above-identified patents, published patent applications, and the FieldView® commercial embodiment, displays visual data maps on the screen of the monitor 80 so the operator can see in real-time with color coding or other visual indicators any instances or occurrences of a detected event.

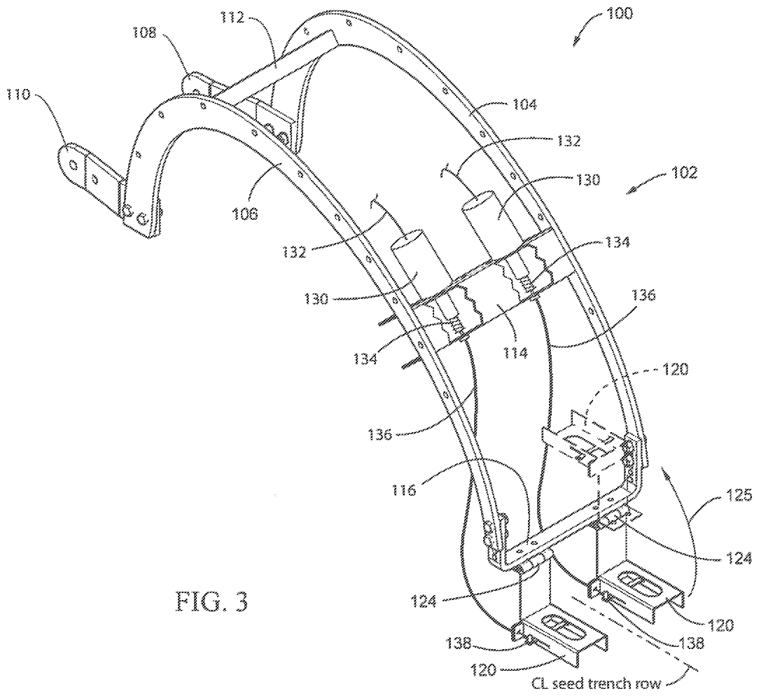

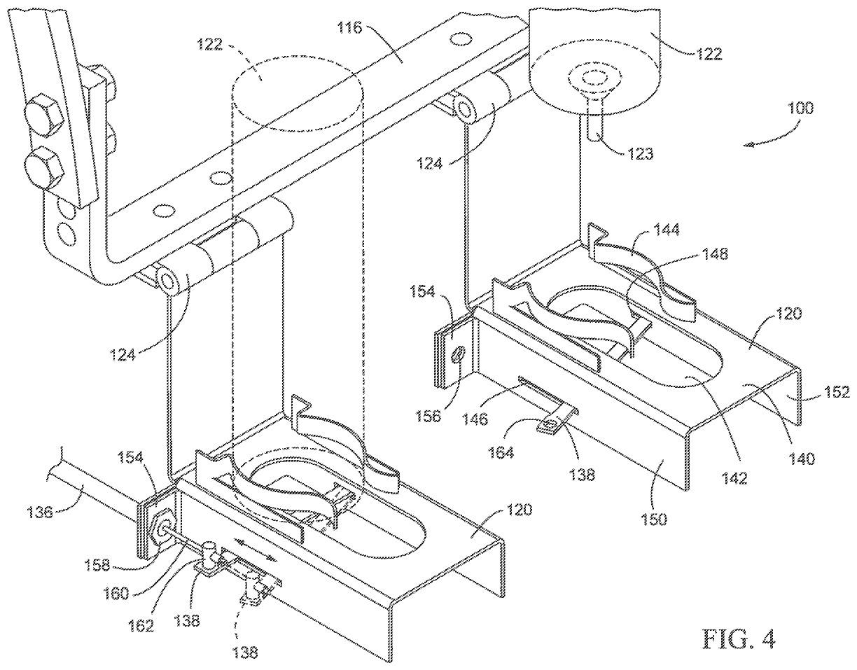

FIGS. 2-4 show one embodiment of a field marking assembly 100 for use with the field marking system 1000. In this embodiment, the field marking assembly 100 includes a rearward extending frame 102 having left and right frame members 104, 106. Forward mounting brackets 108, 110 are connected at the forward end of the left and right frame members 104, 106, respectively, and connect (such as by bolts) to the row unit frame 22. Forward, middle, and rearward lateral members 112, 114, 116 may extend between the left and right frame members 104, 106 to provide structural rigidity to the fame 102. The rearward lateral members 116 may include mounting surfaces for one or more canister holders 120, each of which is configured to hold one or more canisters 122 containing the composition to be applied as visual strips 1001. For example, the canisters 122 may inverted aerosol spray paint canisters for applying spray paint to the soil as the visual strips 1001. In FIGS. 3 and 4, two canister holders 120 are shown spaced along the rearward lateral member 116 such that the two canister holders 120 are on opposite sides of the centerline of the seed trench row. The canister holders 120 may be attached to the rearward lateral members 116 by hinges 124 that permit the canister holders 120 to pivot upward as shown by arrow 125 (FIG. 3) to avoid damage in the event the canister holders 120 contact the ground and for easier storage of the field marking assembly 100 when not in use.

In the embodiment shown in FIGS. 2-4, the middle lateral member 114 supports marker actuators 130. Each marker actuator 130 is associated with a corresponding canister holder 120. Each of the marker actuators 130 are in signal communication with the monitor 80 via a signal line 132. The marker actuators 130 may be linear solenoids having a spring-biased plunger 134 that produces a mechanical push-and-pull force as the plunger 134 moves between an extended position and a retracted position. Each of the spring-biased plungers 134 is respectively coupled to one end of a corresponding Bowden cable 136. The other end of each of the Bowden cables 136 is coupled to a marker lever 138 on a corresponding canister holder 120. In the embodiment shown in FIGS. 2-4, the marker lever 138 is a horizontal-action lever for use with, for example, an aerosol spray canister 122 that uses a tilt-valve to release its contents in the form of spray paint. In some embodiments, the marker actuators 130 may alternatively include a servo motor, a solenoid valve, a linear actuator, a muscle wire, or any other type of actuator.

As shown in FIG. 4, the canister holder 120 may include a base 140 having an elongated opening 142 through which the nozzle 123 of the inverted canister 122 extends. Spring clips 144 are attached to the upper surface of the base 140 for securely holding the inverted canister 122 while the planter 10A traverses the field. The marker lever 138 is slidably movable within opposing slots 146, 148 in downwardly turned opposing flanges 150, 152 of the base 140. The end of the marker lever 138 that is hidden from view in FIG. 4 is loosely retained in the slot 148 by a downturned or upturned lip so the end of the marker lever 138 will not pull through the slot 148. Slot 146 is longer than slot 148 to permit the free end of the marker lever 138 to move along a greater distance forward and rearward. The canister holder 120 includes an ear 154 with an aperture 156 for receiving a threaded end of the Bowden cable 136. The threaded end of the Bowden cable 136 is secured to the ear 154 by a nut 158. The movable internal cable 160 of the Bowden cable 136 is attached to the marker lever 138 by any suitable connector 162. A hole 164 may be provided in the free end of the marker lever 138 for securing the connector 162 to the marker lever 138.

In operation it should be appreciated that when the spring-biased plunger 134 is in the normal extended position, the internal movable cable 160 is extended, which produces a pushing force on the marker lever 138 rearward within the slot 146. However, upon the occurrence of a detected event, the monitor 80 generates a signal to activate or energize the marker actuator 130 to retract the biased plunger 134. The retraction of the spring-biased plunger 134 exerts a pulling force on the internal cable 160, which pulls the marker lever 138 forward within the slot 146, which in turn engages with and causes the nozzle 123 to tilt or bend, opening the valve of the canister 122 and releasing its contents. When the detected event has passed or is no longer occurring, the monitor 80 sends another signal to deactivate or de-energize the marker actuator 130, allowing the spring-biased plunger 134 to return to its normal extended position, which, in turn, exerts a pushing force on the movable internal cable 160, causing the marker lever 138 to move rearward within the slot 146 and out of engagement with the nozzle 123, thus permitting the valve of the canister 122 to close, which stops the release of the canister contents.

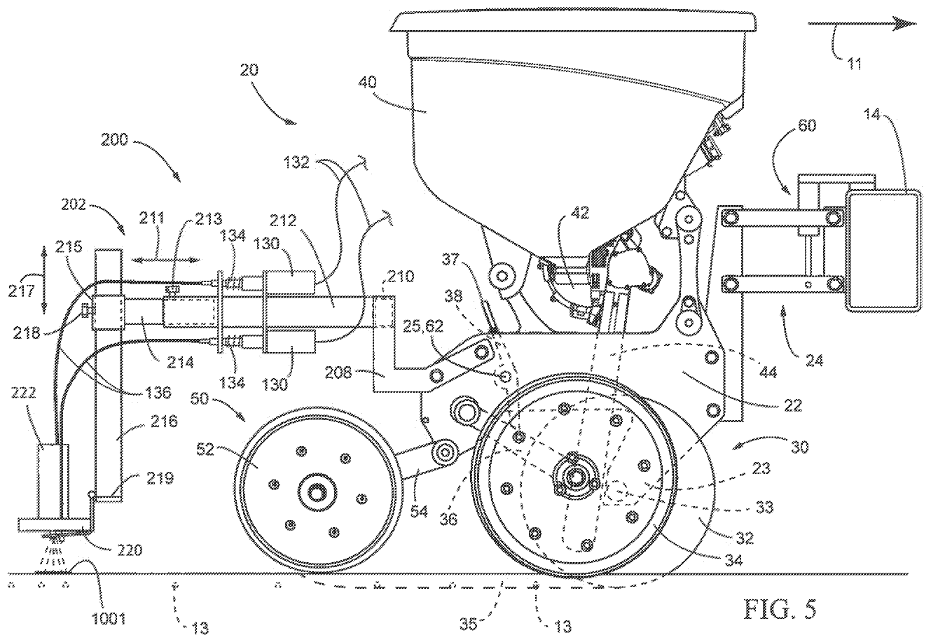

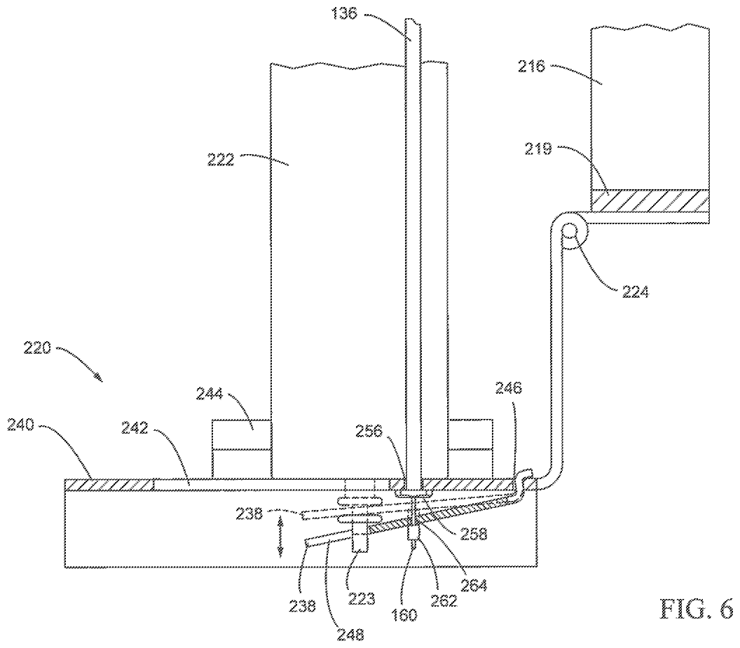

FIG. 5 illustrates another embodiment of a field marking assembly 200 for use with the field marking system 1000. The field marking assembly 200 includes a rearward extending frame 202 supported by forward extending mounting brackets 208 that attach to opposing sides of the row unit frame 22. A cross-beam 210 extends laterally between the mounting brackets 208. The cross-beam 210 supports a longitudinal tubular beam 212. An inner beam 214 is telescopically received in the longitudinal tubular beam 212 such that the inner beam 214 may be moved forward and rearward with respect to the outer longitudinal tubular beam 212, as indicated by arrows 211, to vary the distance that the frame 202 extends rearward of the closing assembly 50. A threaded set bolt 213 extending through the outer longitudinal beam 212 can be tightened to engage the inner beam 214 to adjustably lock the inner beam 214 in position relative to the outer longitudinal tubular beam 212. The rearward end of the inner beam 214 supports a tubular collar 215 that receives a vertical post 216. The vertical post 216 is vertically adjusted relative to the collar 215 as indicated by arrows 217. A threaded set bolt 218 extending through the collar 215 may be tightened to engage the vertical post 216 to adjustably lock the vertical post 216 at the desired height above the soil surface. A rearward lateral plate 219 is supported at the lower end of the vertical post 216 and serves as a mounting surface for one or more canister holders 220, each of which is configured to hold one or more canisters 222 containing the composition to be applied as visual strips 1001. FIG. 6 is an enlarged partial cross-sectional view of the canister holder 220. As in FIGS. 2-4, the canisters 222 are shown as inverted aerosol spray paint canisters for apply spray paint to the soil as the visual strips 1001. Two canister holders 220 may be spaced along the rearward lateral plate 219 such that the two canister holders 220 are on opposite sides of the centerline of the seed trench row. The canister holders 220 may be attached to the rearward lateral plate 219 by hinges 224 that permit the canister holders 220 to pivot upward in the same manner shown by arrow 125 in FIG. 3 to avoid damage in the event the canister holders 220 contact the ground and for easier storage of the field marking assembly 200.

Marker actuators 130 are supported on the frame 202, with each marker actuator 130 associated with a corresponding one of the canister holders 220. Each of the marker actuators 130 are in signal communication with the monitor 80 via a signal line 132. The marker actuators 130 may be linear solenoids having a spring-biased plunger 134 that produces a mechanical push and pull force as the plunger 134 extends and retracts. Each of the spring-biased plungers 134 is coupled to one end of a Bowden cable 136 with the other end of the respective Bowden cable 136 coupled to a marker lever 238 of a corresponding canister holder 220, as shown in FIG. 6. The marker lever 238 may be a vertical-action lever for use with, for example, an aerosol spray canister 122 that uses an up-down valve to release its contents in the form of spray paint.

The canister holder 220 includes a base 240 having an elongated opening 242 through which the nozzle 223 of the inverted canister 222 extends. Spring clips 244 are attached to the upper surface of the base 240 for securely holding the inverted canister 222 while the planter 10A traverses the field. The marker lever 238 may be a thin plate pivotally attached at its forward end to the base 240. In one embodiment, the forward end may include a double-bend in the form of an S-shape, such that one leg of the S-shaped bend extends upward through a vertical opening 246 in the base 240, and with the other leg of the S-shaped bend hooking over the upper surface of the base 240. This S-shaped bend secures the marker lever 238 to the base 240, but allows the marker lever 238 to pivot up and down with respect to the base 240, as shown by the dashed lines for the marker lever 238 in FIG. 6. The rearward end of the marker lever 238 includes a slot 248 into which the nozzle 238 is slidably received. The base 240 includes an aperture 256 for receiving the threaded end of the Bowden cable 136. A nut 258 threadably secures the end of the Bowden cable 136 to the base 240. The movable internal cable 160 of the Bowden cable 136 extends through a hole 264 in the marker lever 238 and is secured to the marker lever 238 by a connector 262 (e.g., a nut, a clamp, etc.).

In operation it should be appreciated that when the spring-biased plunger 134 is in the normal extended position, the internal movable cable 160 is extended, which produces a pushing force downward on the marker lever 238. However, upon the occurrence of a detected event, the monitor generates a signal to activate or energize the marker actuator 130, causing the spring-biased plunger 134 to retract. The retraction of the plunger 134 exerts a pulling force on the internal cable 160, which pivots the marker lever 238 upward into engagement with the nozzle 223, causing the valve of the canister 222 to open and release its contents. When the detected event has passed or is no longer occurring, the monitor 80 sends another signal to deactivate or de-energize the marker actuator 130, allowing the spring-biased plunger 134 to return to its normal extended position, which, in turn, exerts a pushing force on the movable internal cable 160, causing the marker lever 238 to pivot downward and out of engagement with the nozzle 223, thus closing valve of the canister 222 and stopping the release of its contents.

In yet another alternative embodiment, rather than the field marking system 1000 comprising two laterally spaced canister holders 120, 220 on opposing sides of the seed trench row, the field marking assembly 100, 200 may be configured with a single canister holder 120, 220 holding one or more canisters 122, 222. In such embodiments, the single canister holder 120, 220 may be positioned directly over the seed trench row or to only one side of the seed trench row.

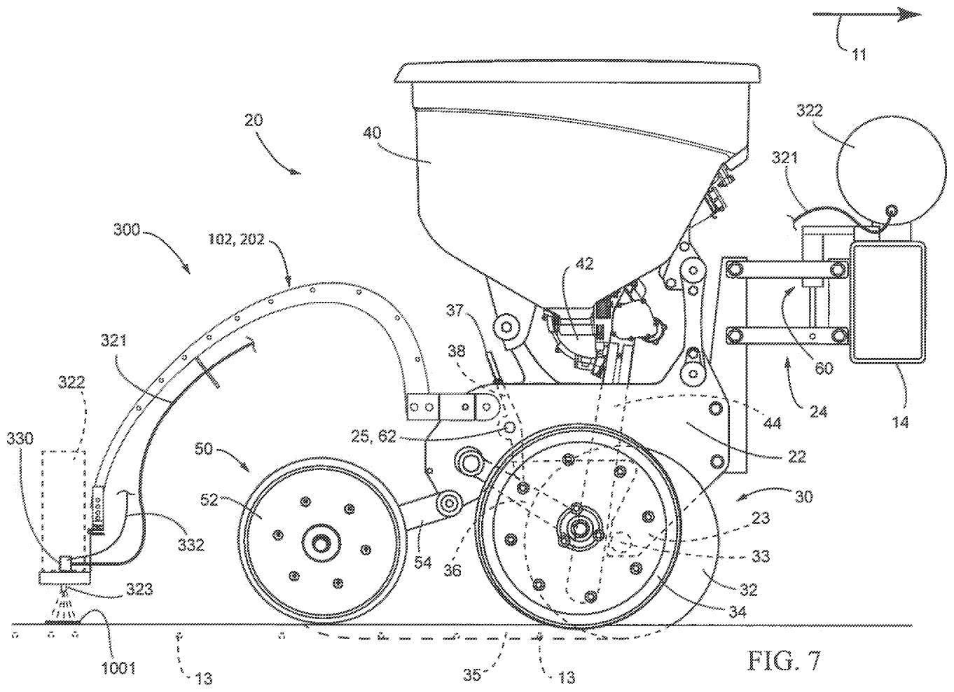

FIG. 7 illustrates another embodiment of a field marking assembly 300 for use with the field marking system 1000. The field marking assembly 300 may have the same or similar rearward extending frames 102, 202 as previously described and shown in FIGS. 2-6. The field marking assembly 300 may have distribution lines 321 to communicate the composition used for the visual strips 1001 from one or more canisters 322 on the implement 10 (e.g., on the boom 14, as shown in FIG. 7), or on the tractor 12. Alternatively, as in the field marking assemblies 100, 200 shown in FIGS. 2-6, the canisters 322 may be supported on the canister holders 120, 220 at the rearward extending frames 102, 202 (as indicated by dashed lines in FIG. 7). The canisters 322 may contain a supply of the composition to be applied as the visual strip 1001 of the same color or different colors as explained later. The monitor 80 may be in signal communication via signal lines 332 with actuators 330 in the form of electronic valves that are actuated to release or apply the composition as the visual strip 1001 onto the soil through spray nozzles 323 upon the occurrence of a detected event. In such an embodiment, the canisters 322 may be pressurized by a compressor or pressurized tank such the composition is discharged and sprayed under pressure upon opening of the electronic valve actuators 330 in response to a signal from the monitor 80. Alternatively, rather than the canisters 322 being pressurized, the compressor or pressurized tank may be in communication with the electronic valve actuators 330, which open to deliver pressurized air to a port to discharge and spray the composition onto the soil under pressure. In another alternative embodiment, the actuators 330 may be replaced by airless electric spray guns in signal communication with the monitor 80 and in fluid communication with the canisters 322, and which spray the composition onto the soil as the visual strip 1001.

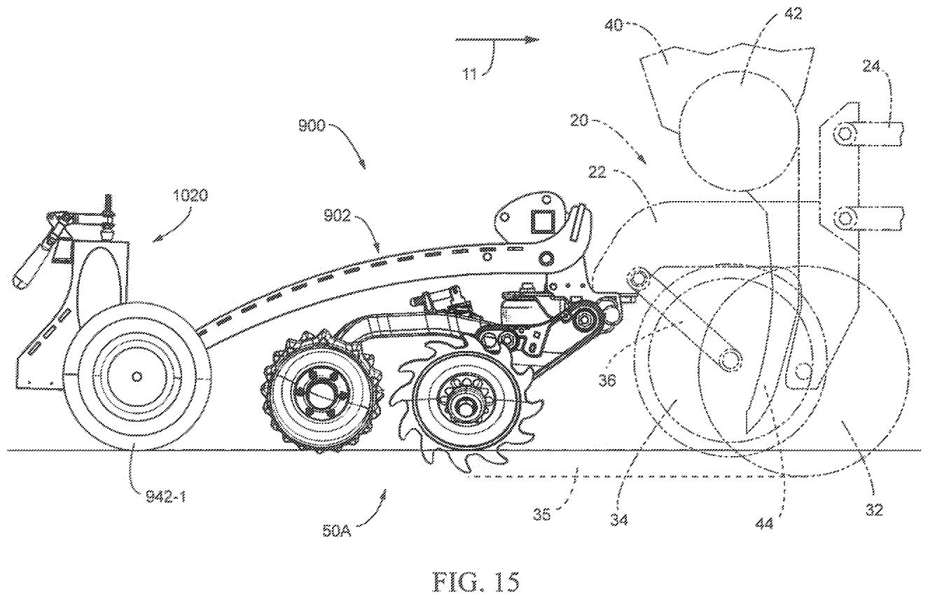

FIGS. 15-21 illustrate another embodiment of a field marking assembly 900 for use with the field marking system 1000. As best viewed in the side elevation view of FIG. 15, the field marking assembly 900 is adapted to mount to the frame 22 of the row unit 20 of a planter 10A and is configured to couple with a trench closing assembly 50A, such as disclosed in International Patent Publication No. WO2019/169369, a commercial embodiment of which is the FurrowForce™ closing system available from Precision Planting LLC.

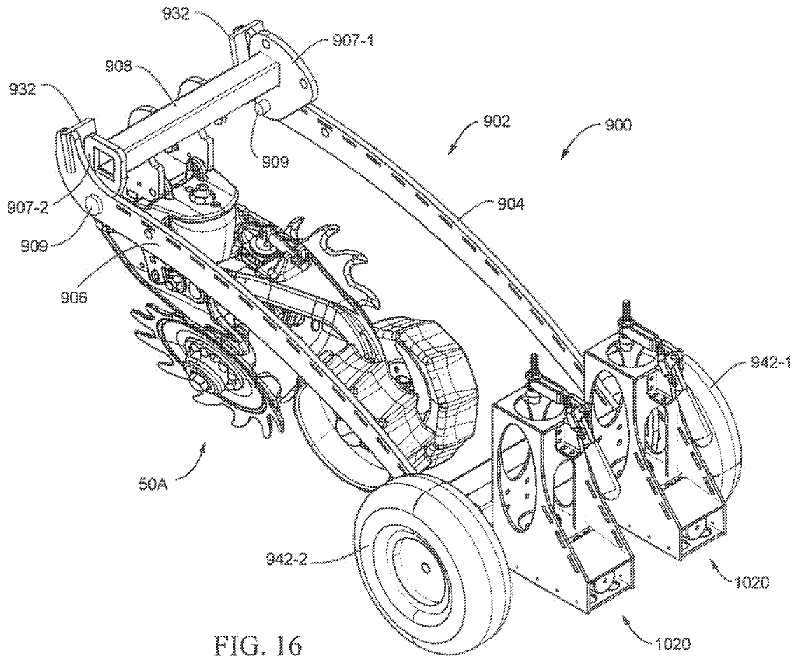

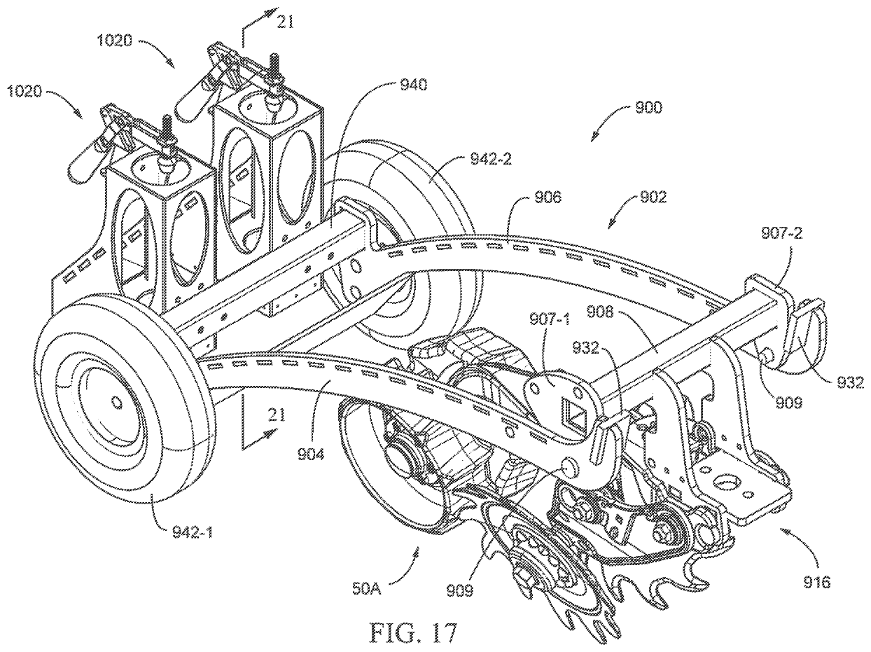

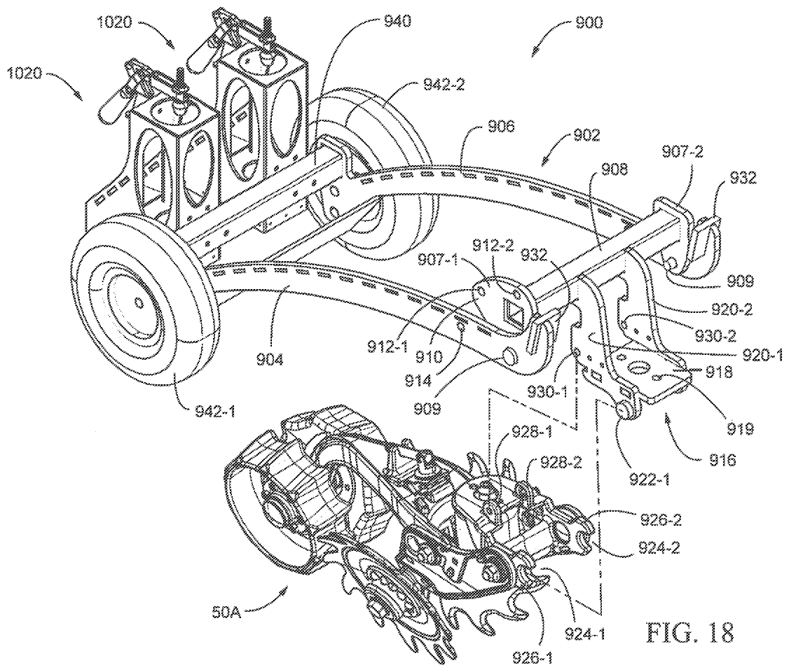

FIGS. 16 and 17 are rear and front perspective views, respectively, of the field marking assembly 900 shown coupled with the trench closing assembly 50A, but with the planter row unit 20 removed for clarity. FIG. 18 is the same front perspective view of the field marking assembly 900 and the trench closing assembly 50A as in FIG. 17, but showing the field marking assembly 900 uncoupled from the trench closing assembly 50A.

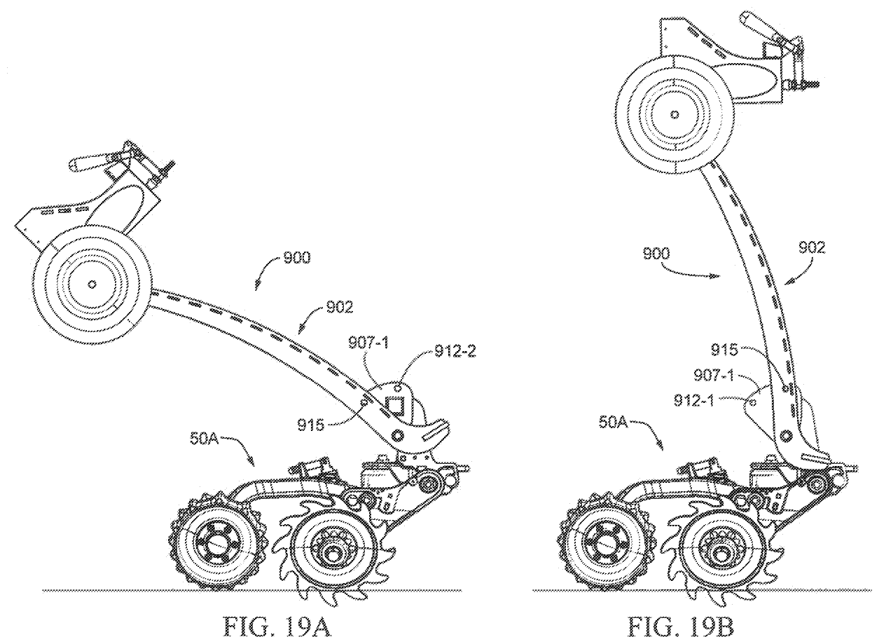

The field marking assembly 900 includes a rearward extending frame 902 comprising left and right frame members 904, 906. A forward lateral brace 908 is provided at the forward ends of the left and right frame members 904, 906 to provide structural rigidity. In one embodiment, the forward ends of the left and right frame members 904, 906 are pivotally secured to side plates 907-1, 907-2 of the forward lateral brace 908 by pivot pins 909. The pivot pins 909 permit the frame 902 to pivot upward as shown in FIGS. 19A and 19B for transport or when the field marking system 1000 is not being used during planting operations. As best viewed in FIG. 18, one side of the forward lateral brace 908 may include a rearward extending lobe 910 having first and second lobe apertures 912-1, 912-2. A mating frame aperture 914 in the adjacent frame member 904 may receive a pin 915 (FIG. 19A, 19B) to secure the frame 902 in the upward pivoted position shown in FIG. 19A when the frame aperture 914 is aligned with the first lobe aperture 912-1, or in a substantially vertical position as shown in FIG. 19B when the frame aperture 914 is aligned with the second lobe aperture 912-2.

Referring to FIG. 18, a forward mounting bracket 916 is supported from the forward lateral brace 908. The forward mounting bracket 916 includes a bottom plate 918 supported by laterally spaced side gussets 920-1, 920-2 extending downward from the forward lateral brace 908. The bottom plate 918 includes apertures 919 for receiving bolts to threadably bolt to the rearward end of the frame 22 of the row unit 20 as shown in FIG. 15. Posts 922-1, 922-2 (which is hidden from view in FIG. 18) project outward from the respective gussets 920-1, 920-2. The posts 922-1, 922-2 are configured to be received by corresponding hooks 924-1, 924-2 on the forward projecting arms 926-1, 926-2 of the trench closing assembly 50A. The trench closing assembly 50A also includes upward projecting lugs 928-1, 928-2, each having an aperture that aligns with corresponding apertures 930-1, 930-2 in the respective gussets 920-1, 920-1 for bolting thereto. Thus, engagement of the posts 922-1, 922-2 in the corresponding hooks 924-1, 924-2, together with the bolted connection of the lugs 928-1, 928-2 with the gussets 920-1, 920-2 rigidly secures the trench closing assembly 50A with the frame 902 of the field marking assembly 900. The bolted connection of the bottom plate 918 of the forward mounting bracket 916 to the rearward end of the frame 22 of the row unit 20 rigidly secures the field marking assembly 900 together with the trench closing assembly 50A to the row unit 20.

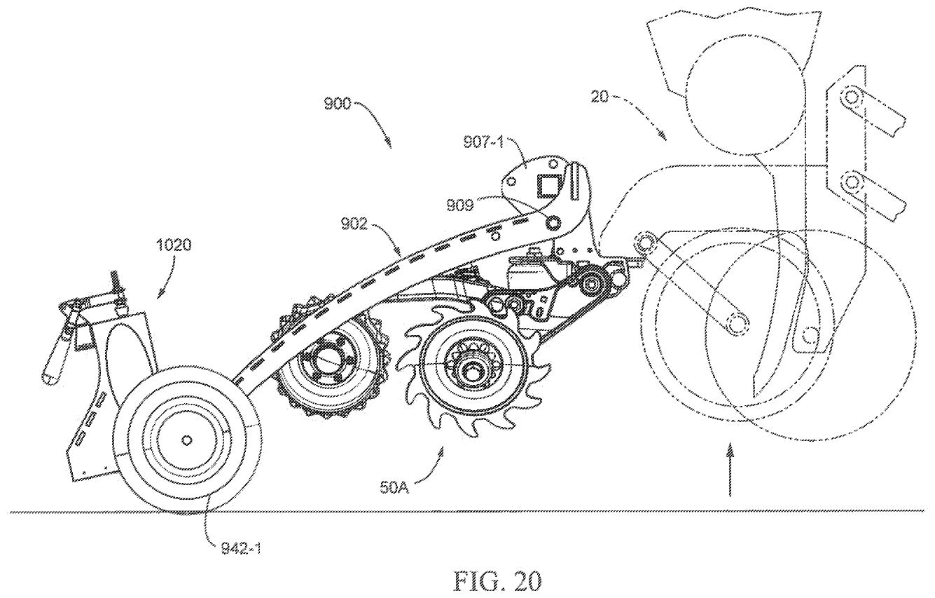

Referring to FIGS. 16 and 20, the forward ends of the left and right frame members 904, 906 include inward projecting transverse plates 932 that abut the respective side plates 907-1, 907-2 of the forward lateral brace 908 to serve as stops. As shown in FIG. 20, when the row unit 20 is raised above the soil surface during planting operations (such as when turning at headlands of the field), these stops prevent the frame 902 of the field marking assembly 900 from pivoting downward (about pivot pins 909) below the trench closing assembly 50A.

Referring to FIGS. 17 and 18, the frame 902 of the field marking assembly 900 includes a rearward lateral member 940 for structural rigidity. The rearward lateral member 940 supports a pair of wheels 942 and may also serve as a mounting surface for one or more canister holders 1020. For purposes of this embodiment, two canister holders 1020 are shown spaced along the rearward lateral member 940 such that the two canister holders 1020 and the canisters 1022 therein are positioned on opposite sides of the centerline of the seed trench row.

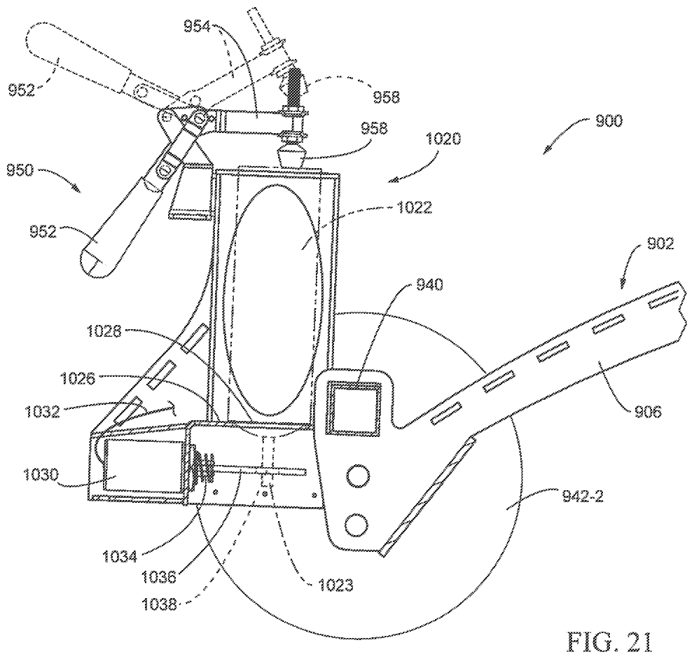

Referring to FIG. 21, which is a cross-sectional view as viewed along line 21-21 of FIG. 17, the canister holder 1020 may include an enclosure 1024 sized to receive a canister 1022 containing the composition to be applied as visual strips 1001. The canister 1022 is shown as an inverted aerosol spray paint canister for applying spray paint to the soil as the visual strips 1001. The canister holder 1020 includes a base 1026 having an opening 1028 through which the nozzle 1023 of the inverted canister 1022 extends. The canister holder 1020 includes a canister restraint 950 for securing the canister 1022 within the enclosure 1024. The canister holder 1020 includes a lever 952 pivotally connected to an arm 954. The arm 954 is pivotally attached at one end to a bracket 956 attached to the enclosure 1024. The other end of the arm 954 extends over the canister 1022 and supports a bumper 958 that is threadably adjustable with respect to the arm 954 to engage with and hold the bottom of the inverted canister 1022 stable within the enclosure 1024 when the lever 952 is in the downward or locked position as shown in solid lines in FIG. 21. To release the canister 1022, the lever 952 is pulled upward to the release position as shown in dashed lines in FIG. 21, which lifts the bumper 958 out of engagement with the bottom of the inverted canister 1022.

An actuator 1030 is on the canister holder 1020 for each canister 1022. Each of the actuators 1030 is in signal communication with the monitor 80 via signal lines 1032. In this embodiment, the actuators 1030 are linear solenoids, having a spring-biased plunger 1034 coupled to a plate 1036 having a hole 1038 therethough. The canister nozzle 1023 is positioned to extend through the hole 1038 in the plate 1036. Upon the occurrence of a detected event, the monitor 80 generates a signal to activate or energize the actuator 1030, causing the spring-biased plunger 1034 to extend or retract. This action pushes or pulls on the nozzle 1023 extending through the hole 1038 on the plate 1036 coupled to the plunger 1034, which opens the valve of the canister 1022 to release the composition through the nozzle 1023 as a visual strip 1001. Alternatively, the field marking assembly 900 may use the embodiments of the pivoting canister holders 120, 220 as previously described and use the canisters 122, 222, 322 and/or a compressor or pressurized tank or airless electric spray guns in cooperation with the various actuators 130, 330, which may be mechanically or electrically coupled to release the contents of the canisters as visual strips 1001 in response to a signal from the monitor 80.

While described herein using monitor 80, a single-row control module 81 (FIG. 1) can alternately control the field marking system 1000 (such as an SRM module available from Precision Planting LLC or as described in U.S. Pat. No. 9,332,689, “Systems, methods, and apparatus for multi-row agricultural implement control and monitoring,” granted May 10, 2016. Single-row control module 81 can be placed at each row, as illustrated in FIG. 1 as single-row control modules 81-1 to 81-16, or each row module can control a plurality of rows. Monitor 80, single-row control module 81, or both can be a controller.

Field Marking Options

In one embodiment, whether the field marking system 1000 includes the field marking assemblies 100, 200, 300, 900 having canister holders 120, 220, 1020 and canisters 122, 222, 322, 1022 and/or distribution lines and/or a compressor or pressurized tank or airless electric spray guns in cooperation with the various actuators 130, 330 to release the contents of the canisters as visual strips 1001, the system 1000 may apply visual strips 1001 of a single color (such as orange) for all detected events regardless of the type of detected event. Visual strips 1001 of a single color may be adequate because the visual data map on the screen of the monitor 80 will identify the particular type of detected event that occurred, and thus the field marking system 1000 will apply the visual strip 1001 of any desired color to simply designate the location within the field of the detected event independent of the type of detected event that occurred.

In another embodiment, the system 1000 may be configured to apply visual strips 1001 of different colors, with each color associated with a particular type of detected event. For instance, referring to FIG. 1 as a non-limiting example, upon the detection of a seed skip detected event in a seed trench row, the field marking system 1000 may be programmed to apply a visual strip 1001 of a first color so that the first color is applied onto the soil adjacent to the seed trench row to identify where a seed skip occurred. Whereas, upon the detection of a seed multiple detected event or improper spacing detected event in a seed trench row, the system 1000 may be programmed to apply a visual strip 1001 of a second color onto the soil adjacent to the seed trench row to identify and differentiate where the poor spacing or seed multiple detected event occurred versus a seed skip detected event.

In some embodiments, for the field marking assemblies 100, 200, 900 that have canister holder(s) 120, 220, 1020, each of the canister holders 120, 220, 1020 may be configured to hold more than one canister 122, 222, 322, 1022, with each canister 122, 222, 322, 1022 having a marker actuator 130, 330, 1030 coupled mechanically or electronically as previously described to release the contents of the canisters 122, 222, 322, 1022. In such embodiments, the canisters 122, 222, 322, 1022 may contain compositions of different colors to be applied as visual strips 1001 onto the soil with a particular color corresponding to a particular type of detected event. For instance, as non-limiting examples, the field marking system 1000 may be programmed to apply a red visual strip 1001 adjacent to a seed trench row where a seed skip is detected; to spray an orange visual strip 1001 adjacent to a seed trench row where a seed multiple or improper seed spacing is detected; and to apply a yellow visual strip 1001 adjacent to a seed trench row that is not adequately closed, etc. In yet another example, the system 1000 may be programmed to apply a visual strip 1001 using two colors simultaneously on one side or both sides of a seed trench upon the occurrence of another type of detected event. The colors of the visual strips 1001 may be the same color coding as reflected on the on-screen display of the monitor 80.

Rather than visual strips 1001 of one color or different colors being applied upon the occurrence of each detected event, the system 1000 may be programmed to apply visual strips 1001 of a single color or multiple colors only when a detected event is outside a predetermined range. For example, as non-limiting examples, the system 1000 may be programmed so a visual strip 1001 is applied on the soil when a predetermined minimum number of consecutive seed skips occur, or when a predetermined minimum number of consecutive seed multiples occur, or when a predetermined minimum number of consecutive poor seed spacings occur. In another non-limiting example, if for instance, the row unit downforce is being monitored, the system 1000 may be programmed to apply a visual strip 1001 of one color if the downforce is either below a minimum predetermined downforce or above a maximum predetermined downforce, or the system 1000 may be programmed to apply a visual strip 1001 of one color if the downforce falls below a minimum predetermined downforce and another color if the downforce exceeds a maximum predetermined downforce. Alternatively, the system 1000 may be programmed to apply visual strips 1001 of different colors corresponding to different ranges of downforce. It should be appreciated that downforce is but one example, and other visual strips 1001 of different colors or patterns may be applied for any detected events that are above or below predetermined ranges or thresholds or frequencies of occurrences.

Depending on the relative position of the spray nozzles 123, 223, 323, 1023 for the field marking assembly 100, 200, 300, 900 with respect to the location on the implement 10 where the detected event occurs and depending on the speed of travel of the implement 10, the monitor 80 may be programmed with a delay in order to actuate the actuators 130, 330, 1030 to apply the visual strip 1001 at the correct time so that the visual strip 1001 is applied to the soil over or adjacent to the location where the detected event will be found in the soil. For instance, by way of non-limiting examples, if the implement 10 is a singulating planter and it is desired to apply a visual strip 1001 to the soil to identify the location of a seed skip detected event, a delay may be programmed to account for the speed of the planter, the period of time it takes for the seed to be deposited in the seed trench from the point at which the seed skip was detected in the seed tube or seed conveyor 44, and to account for the distance rearward of the spray nozzles 123, 223, 323, 1023 from the seed deposit location so that the visual strip 1001 is applied at the time that the nozzle 123, 223, 323, 1023 passes over the seed skip in the seed trench. Similarly, if the adequacy of the seed trench closing is the detected event, a delay may be programmed to account for the speed of the planter and for the distance rearward of the seed trench closing sensor from the nozzles 123, 223, 323, 1023 so that the visual strip 1001 is applied at the time that nozzle 123, 223, 323, 1023 passes over the inadequately closed seed trench location.

### OTHER IMPLEMENT EMBODIMENTS

As previously stated, rather than the implement 10 being a singulating row crop planter as shown in FIG. 1, the implement 10 may instead be an air seeder implement as is well known in the art. For an air seeder implement 10, the arrangement of the field marking assembly may be similar to the embodiments 100, 200, 300, 900 described above, and the types of detected events may be similar to those previously described. However, because air seeders typically plant seeds at a much greater population or seed rate as compared to singulating row crop planters, the types of detected events associated with an air seeders would typically not include the detection of each seed skip, each seed multiple, or each poor spacing. Rather, for an air seeder implement, the detected events may include, as non-limiting examples, occurrence of the detection of no-flow or low-flow of seeds through any row unit distribution tubes, or seed application rates outside predetermined ranges, a seed trench closing forces outside predetermined ranges, ride quality outside predetermined ranges (e.g., a vertical velocity magnitude greater than specified threshold, as calculated from vertical accelerometers or other inertial sensors, as described in U.S. Pat. No. 8,078,367, mentioned above), soil moisture outside predetermined ranges, soil temperature outside predetermined ranges, organic matter outside predetermined ranges, etc., and the visual strips 1001 may be applied to the soil where such detected events occur.

It should be appreciated that while the field marking system 1000 is particularly suited for marking the soil with visual strips 1000 to identify occurrences of detected events during planting or seeding operations, the field marking system 1000 may be used throughout the crop-growing season to continue to visually mark areas of the field where detected events occurred during planting operations so the grower can continue to identify and monitor the plants at such locations. In addition, the field marking system 1000 may be used to visually mark areas of the field where other detected events occurred during other field operations.

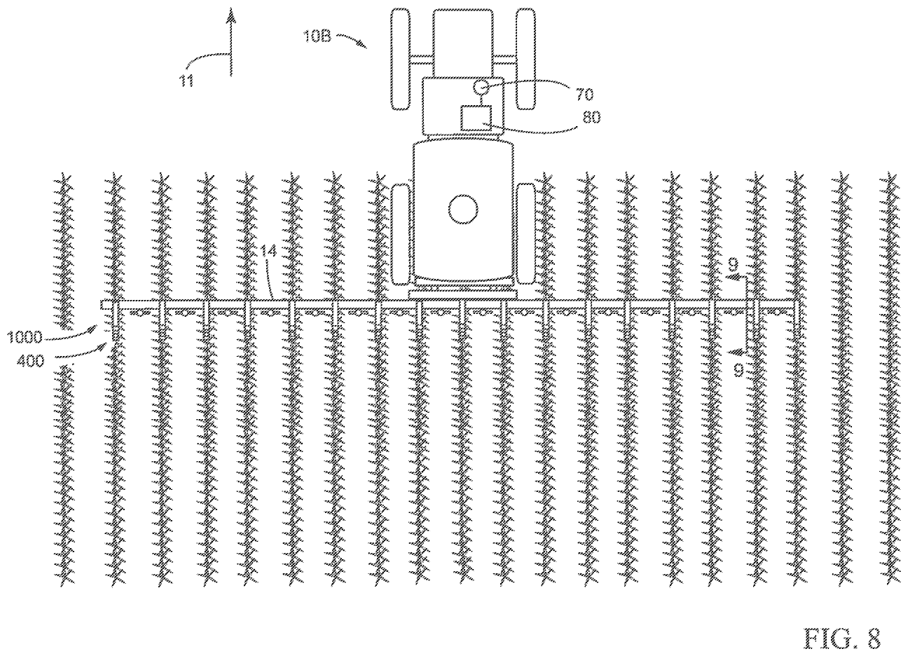

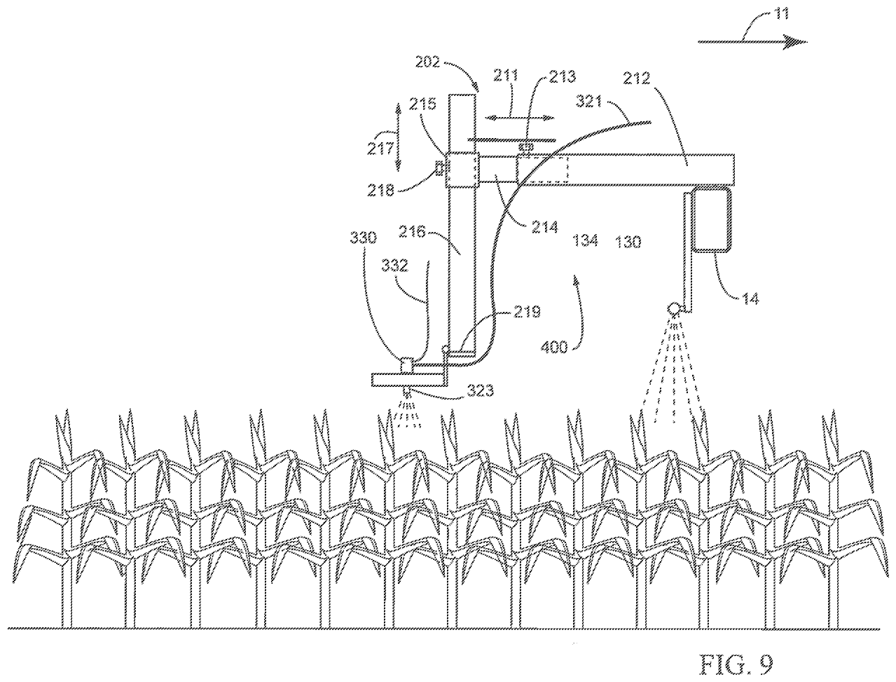

For example, referring to FIGS. 8 and 9, the field marking system 1000 is shown configured for use with a sprayer implement 10B. The sprayer implement 10B may be a self-propelled sprayer as shown or the sprayer implement may be of a type that is drawn through the field by a tractor 12. Because sprayer implements 10B are usually operated at later growth stages after the crops have emerged, the system 1000 may be configured to apply visual strips 1001 onto the growing crops rather than onto the soil surface because the growing crops may be obscuring the soil. In such an embodiment, the structure and operation of the field marking assembly may 400 be substantially the same as any of the embodiments 100, 200, 300, 900 described above, but with frames 102, 202, 902 being mounted to extend rearward from the boom 14, toolbar, or other support structure of the sprayer implement 10B and with the nozzles 123, 223, 323, 1023 positioned above and aligned over the respective crop rows so that the visual strip 1001 is applied onto the growing plants instead of onto the soil between the growing plants for easier identification of the occurrences of the detected events.

The types of detected events triggering the visual marking of the field during spraying operations may include, as non-limiting examples, occurrence of the detection of no-flow or low-flow of the liquid product or granular product being applied to the field through any of the product distribution lines of the sprayer implement 10B, occurrences of flow rates outside predetermined ranges, points where different application rates occur, or when switches occur of different products being applied, etc.

In addition or alternatively, the field marking system 1000 may be programmed to apply the visual strip 1001 onto the crops at the same location where the detected events occurred during planting operations so the grower can continue to identify and monitor the plants at such locations. In such an embodiment, the sprayer implement 10B (or the tractor 12 pulling the sprayer implement 10B) includes a GPS receiver 70 and a monitor 80. The monitor 80 may be the 20/20 SeedSense® monitor using the FieldView® system previously described. The data file containing the GPS coordinates of the detected events recorded during planting operations may be uploaded to the monitor 80. When the sprayer implement 10B passes the GPS coordinates of the detected events recorded during planting operations, the system 1000 is programmed to actuate the actuators 130, 330, 1030 to cause the visual strip 1001 to be applied onto the crops at the time the nozzles 123, 223, 323, 1023 pass over the GPS coordinates of those prior detected events. As previously described, the monitor 80 may be programmed with a delay in order to actuate the actuators 130, 330, 1030 to apply the visual strip 1001 to the crops at the correct time so that the visual strip is applied onto the plants at the location where the detected event occurred during planting operations. Thus, the monitor may be programmed to take into account the speed of the sprayer implement and the offset of the nozzles 123, 223, 323, 1023 from the GPS receiver 70.

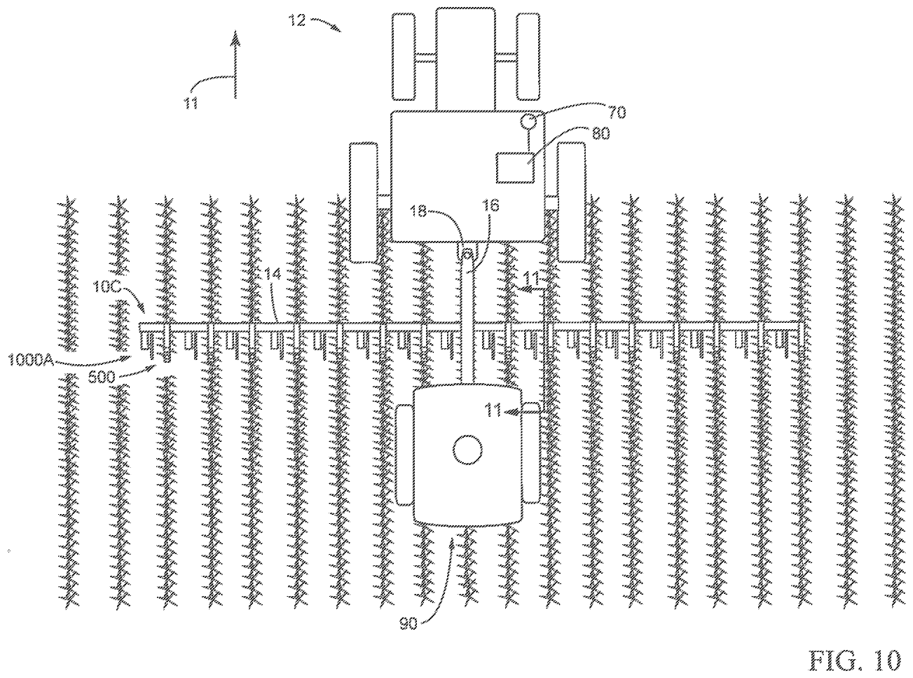

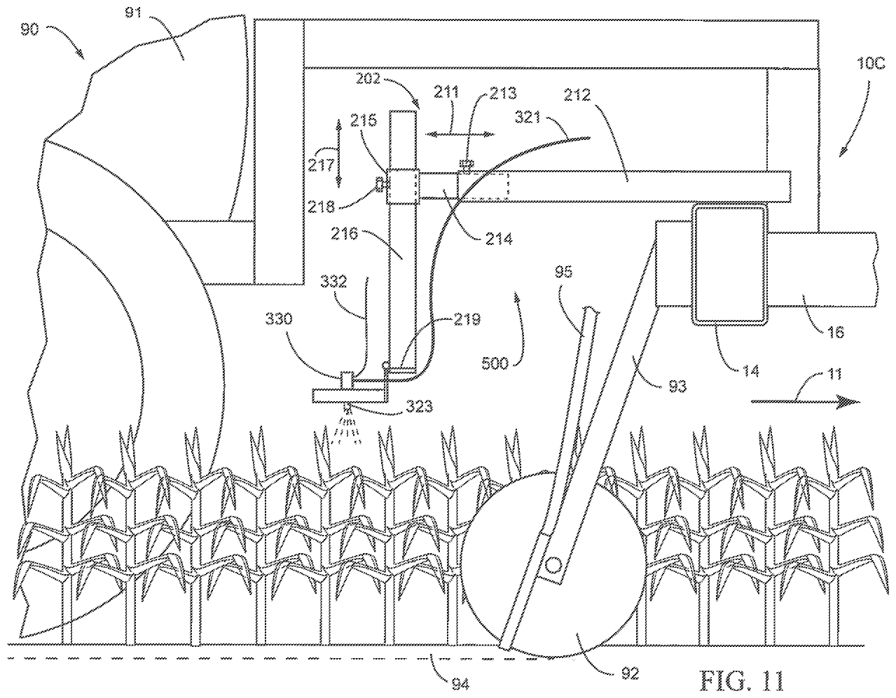

FIGS. 10 and 11 illustrate another example of the field marking system 1000 configured for use during side-dressing operations. A side-dress applicator implement 10C may be drawn through the field by a tractor 12 or may be self-propelled. The side-dress implement 10C is shown as being connected by a hitch 16 to the tractor's drawbar IS. Alternatively, the side-dress implement 10C may be mounted to the tractor 12 by a three-point hitch as is well known in the art. The toolbar 14 of the side-dress implement 10C may be supported by wheel assemblies adapted to raise and lower the toolbar 14 with respect to the soil surface between an operating position and a travel position. The side-dress implement 10C may include a cart 90 having a holding tank 91 containing the liquid product being applied by the side-dress implement 10C. Alternatively, one or more holding tanks 91 containing the liquid product being applied may be supported on the frame of the side-dress implement 10C or the tanks may be supported on the toolbar 14 or tractor 12. As best viewed in FIG. 11, which is a partial cross-sectional view along lines 11-11 of FIG. 10, the side-dress implement 10C includes a disk 92 rotatably supported on a downward extending arm 93. In operation, the disk 92 cuts a furrow 94 in the soil between the crop rows. Liquid product is communicated from the tank 91 through delivery tubes 95, which deliver the liquid product into the furrow 94 cut or opened by the disk 92.

Like spraying operations, side-dress operations are usually performed at later growth stages after the crops have emerged. Accordingly, in this embodiment, the system 1000 is configured to apply visual strips 1001 onto the growing crops rather than onto the soil surface because the growing crops may be obscuring or covering the soil. The structure and operation of the field marking assembly 500 for the side-dress implement 10C may be substantially the same as any of the embodiments 100, 200, 300, 1030 described above, but with frames 102, 202, 902 mounted to extend rearward from the toolbar 14 or other support structure of the side-dress implement 10C and with the nozzles 123, 223, 323, 1023 positioned above and aligned over the respective crop rows so that the visual strip 1001 is applied onto the growing plants instead of onto the soil between the growing plants for easier identification of the occurrences of the detected events.

The types of detected events triggering the visual marking of the field during side-dress operations may include, as non-limiting examples, detection of no-flow or low-flow of the liquid or granular product being applied to the filed through any of the distribution lines of the side-dress applicator implement 10C, occurrences of flow rates outside predetermined ranges, occurrences of different application rates, or switches between different products applied, etc.

In addition or alternatively, the field marking system 1000 may be programmed to apply the visual strip 1001 onto the crops at the same location where the detected events occurred during planting and/or spraying operations so the grower can continue to identify and monitor the plants at such locations. In such an embodiment, the side-dress implement 10C (or the tractor 12 pulling the side-dress implement 10C) includes a GPS receiver 70 and a monitor 80. The monitor 80 may be the 20/20 SeedSense® monitor using the FieldView® system previously described.

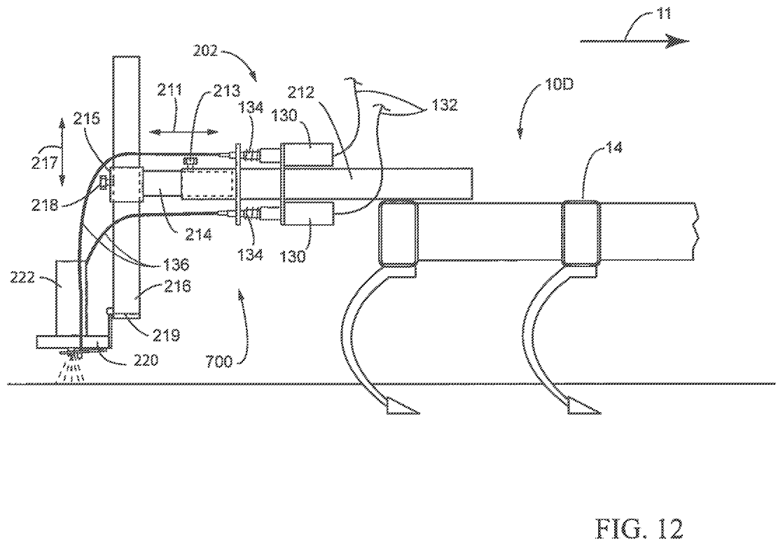

As another embodiment, referring to FIG. 12, the implement 10 may be a tillage implement 10D, which may be drawn through the field by a tractor 12 or may be mounted to the tractor's three-point hitch. For tillage implements 10D, the field marking assembly 700 may be similar to the embodiments 100, 200, 300, 900 described above in connection with the planter 10A, but with the frame 102, 202, 902 mounted to and extending rearward from a beam or other structure supporting the tillage implement 10D. Similar to the field marking system 1000 for planting implements 10A, the field marking system 1000 for tillage operations is programmed to actuate the actuators 130, 330, 1030 to cause the visual strip 1001 to be applied onto the soil surface at the time the nozzles 123, 223, 323, 1023 pass over a detected event.

The types of detected events triggering the visual marking of the field during tillage operations may include, as non-limiting examples, occurrence of a tillage depth outside a predetermined range, downforce outside a predetermined range, etc. As previously described, the monitor 80 may be programmed with a delay in order to actuate the actuators 130, 330, 1030 to apply the visual strip 1001 to the soil at the correct time so that the visual strip is applied onto the soil at the location where the detected event occurred during tillage operations. Thus, the monitor 80 may be programmed to take into account the speed of the tillage implement 10D and the offset of the nozzles 123, 223, 323, 1023 from the GPS receiver 70 in the tractor pulling the tillage implement 10D.

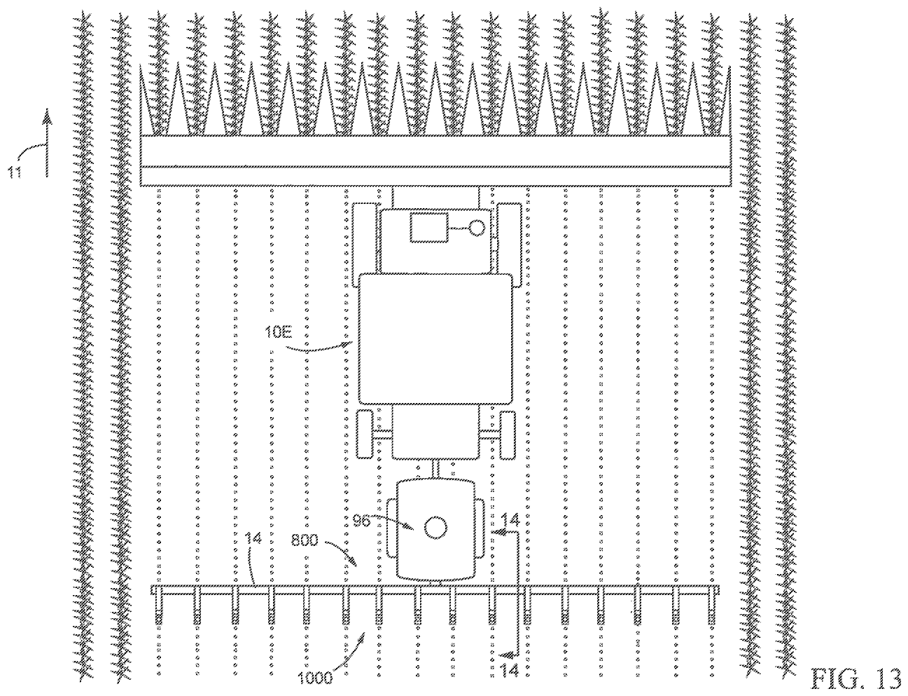

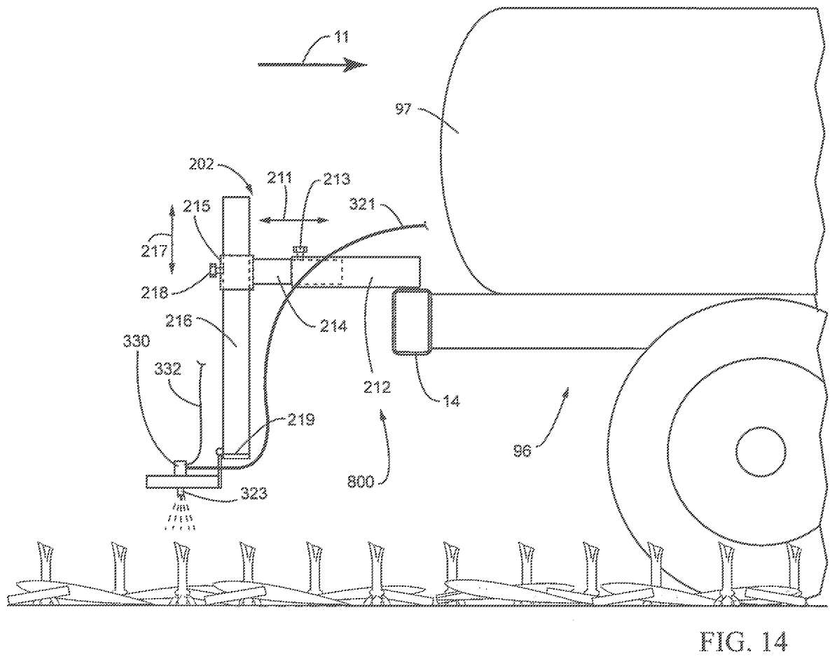

FIGS. 13 and 14 illustrate another example of the field marking system 1000 configured for use during harvesting operations. FIG. 13 illustrates a combine harvester IOE shown in plan view harvesting corn. It should be appreciated, however, that the field marking system 1000 may be used with any harvesting implement for any type of crop. In this embodiment, the field marking system 1000 includes a cart 96 being pulled behind the combine harvester IOE. The cart 96 includes a tank 97 which holds the composition for visually marking the field with the visual strips 1001. As best shown in the cross-sectional view of FIG. 14 as viewed along lines 14-14 of FIG. 13, the structure and operation of the field marking assembly 800 is the same as the embodiment 300 described above, but the field marking assembly 800 may use any of the other embodiments 100, 200, 900 described above. However, in this embodiment, the frames 102, 202, 902 of the field marking assembly 800 are mounted to a toolbar 14 attached to the frame of the cart 96. As shown, the nozzles 123, 223, 323, 1023 are positioned above and aligned over the respective crop rows so that the visual strip 1001 is applied onto the stubble of the harvested crop rows instead of on the ground between the stubble rows, which is often covered with crop debris, for easier identification of the detected events.

The types of detected events triggering the visual marking of the field during harvesting operations may include, as non-limiting examples, excess grain loss, low yield, etc.

In addition or alternatively, the field marking system 1000 may be programmed to apply the visual strip 1001 onto the stubble of the crop rows at the same location where the detected events occurred during planting, spraying, or side-dress operations so the grower can identify where such locations occurred within the harvested field. In such an embodiment, the harvester implement IOE includes a GPS receiver 70 and a monitor 80. The monitor 80 may be the 20/20 SeedSense® monitor using the FieldView® system previously described.

All references cited herein are incorporated herein in their entireties. If there is a conflict between definitions herein and in an incorporated reference, the definition herein shall control.

Various modifications to the embodiments and the general principles and features of the apparatus, systems, and methods described herein will be readily apparent to those of skill in the art. Thus, the foregoing description is not to be limited to the embodiments of the apparatus, systems, and methods described herein and illustrated in the drawing figures.

1. A method of marking a field to identify a location where a detected event occurred within the field, the method comprising:
detecting or retrieving an occurrence of an event during a field operation, wherein the event is selected from the group consisting of seed skips, seed multiples, seed spacing outside a predetermined range, downforce outside a predetermined range, trench depth outside a predetermined range, seed trench closing force outside a predetermined range, ride quality outside a predetermined range, soil moisture outside a predetermined range, soil temperature outside a predetermined range, and organic matter outside a predetermined range; and
applying a composition using an agricultural implement to visually mark a location within the field where the detected event occurred during the field operation.

2. The method of claim 1, wherein detecting or retrieving an occurrence of an event during a field operation comprises detecting, with a singulating planter, an occurrence of at least one event selected from the group consisting of a seed skip, a seed multiple, seed spacing outside a predetermined range, an applied downforce outside a predetermined range, a trench depth outside a predetermined range, a seed trench closing force outside a predetermined range, ride quality outside a predetermined range, soil moisture outside a predetermined range, soil temperature outside a predetermined range, and organic matter outside a predetermined range.

3. The method of claim 1, wherein detecting or retrieving an occurrence of an event during a field operation comprises detecting, with an air seeder, an occurrence of at least one event selected from the group consisting of no-flow of seeds through a row unit distribution tube, low-flow of seeds through the row unit distribution tube, a seed application rate outside a predetermined range, downforce outside a predetermined range, a trench depth outside a predetermined range, a seed trench closing force outside a predetermined range, ride quality outside a predetermined range, soil moisture outside a predetermined range, soil temperature outside a predetermined range, and organic matter outside a predetermined range.

4. The method of claim 1, wherein detecting or retrieving an occurrence of an event during a field operation comprises detecting an occurrence of at least one event selected from the group consisting of no-flow of product through a distribution line a flow rate of product through a distribution line outside a predetermined range, and an application rate of product outside predetermined range.

5. (canceled)

6. The method of claim 1, wherein detecting or retrieving an occurrence of an event during a field operation comprises detecting an occurrence of at least one event selected from the group consisting of tillage depth outside a predetermined range and tillage implement downforce outside predetermined range.

7. The method of claim 1, wherein detecting or retrieving an occurrence of an event during a field operation comprises detecting an occurrence of at least one event selected from the group consisting of excess crop loss in a combine harvester and low yield in the combine harvester.

8. (canceled)

9. The method of claim 1, wherein applying a composition comprises applying the composition onto plants growing within the field.

10. The method of claim 1, wherein applying a composition comprises applying the composition onto stubble of harvested crops within the field.

11.-12. (canceled)

13. The method of claim 1, wherein applying the composition comprises applying a liquid stored under pressure on the agricultural implement.

14. The method of claim 13, wherein applying the composition comprises applying a liquid from an inverted aerosol canister.

15. The method of claim 1, wherein applying the composition comprises applying a liquid having a color corresponding to a particular type of the detected event.

16. The method of claim 1, wherein applying the composition comprises applying a first liquid having a first color when the detected event is below a predetermined range and wherein applying the composition comprises applying a second liquid having a second color different from the first color when the detected event is above a predetermined range.

17. (canceled)

18. A system for marking a field to identify a location where a detected event occurred within the field, the system comprising:
an agricultural implement configured to advance through a field in a forward direction of travel;
at least one sensor configured to generate a sensor signal indicative of an operating condition of the agricultural implement at a location on the field, wherein the operating condition comprises a detected event selected from the group consisting of seed skips, seed multiples, seed spacing outside a predetermined range, downforce outside a predetermined range, trench depth outside a predetermined range, seed trench closing force outside a predetermined range, ride quality outside a predetermined range, soil moisture outside a predetermined range, soil temperature outside a predetermined range, and organic matter outside a predetermined range;
a controller in communication with and responsive to the generated sensor signal, the controller configured to send actuation signals; and
a marking assembly supported by the agricultural implement, the marking assembly comprising:
a supply of a colored composition; and
an actuator configured to receive the actuation signals sent by the controller, the actuator responsive to the actuation signals to release the colored composition at the location on the field while the agricultural implement advances through the field in the forward direction of travel.

19. The system of claim 18, wherein the agricultural implement comprises a singulating planter and the at least one sensor comprises at least one sensor selected from the group consisting of a seed sensor, a downforce sensor, a trench depth sensor, a trench closing sensor, a ride quality sensor, a soil moisture sensor, a soil temperature sensor, and an organic matter sensor.

20. The system of claim 18, wherein the agricultural implement comprises an air seeder and the at least one sensor comprises at least one sensor selected from the group consisting of an air flow sensor, a seed flow sensor, a downforce sensor, a trench depth sensor, a trench closing sensor, a ride quality sensor, a soil moisture sensor, a soil temperature sensor, and an organic matter sensor.

21. The system of claim 18, wherein the the at least one sensor comprises a flow rate sensor.

22. (canceled)

23. The system of claim 18, wherein the agricultural implement comprises a tillage implement and the at least one sensor comprises at least one sensor selected from the group consisting of a depth sensor and a downforce sensor.

24. The system of claim 18, wherein the agricultural implement comprises a combine harvester and the at least one sensor comprises at least one sensor selected from the group consisting of a crop loss sensor and a yield sensor.

25.-26. (canceled)

27. The system of claim 18, wherein the assembly is configured to release the colored composition onto stubble of harvested crops within the field.

28.-30. (canceled)

31. The system of claim 30, wherein the colored composition comprises a liquid contained in an aerosol canister.

32. (canceled)
